(19) United States
(12) Patent Application Publication
(10) Pub. No.: US 2022/0294026 A1
(43) Pub. Date: Sep. 15, 2022

(54) SYSTEMS METHODS AND DEVICES FOR PLANT-BASED POWER SOURCES

(71) Applicant: Ikechukwu Wilson Agbor, Frisco, TX (US)

(72) Inventor: Ikechukwu Wilson Agbor, Frisco, TX (US)

(21) Appl. No.: 17/200,809

(22) Filed: Mar. 13, 2021

(51) Int. Cl. H01M 10/36; H01M 10/0565; H01M 6/18; H01M 6/04; H01M 50/204; H01M 50/247

(52) U.S. Cl. CPC H01M 10/36; H01M 10/0565; H01M 6/181; H01M 6/045; H01M 50/204; H01M 50/247; H01M 2300/0082; H01M 2300/0002; H01M 2220/30

(57) ABSTRACT

The present application is directed to systems, methods and devices which utilize plant based materials as an electrolyte in a power source. Embodiments may process leaves to form materials to be included in one or more of a liquid, paste, or paper-based battery cell. In some embodiments the leaf-based materials may be the primary electrolyte in the battery cell, while in other embodiments the leaf-based materials may be combined with other materials to provide for the chemical materials within the battery cell. In additional embodiments, the leaves may be processed with a textile or leather material to form a wearable cell.

### TECHNICAL FIELD

The present application relates to electrical storage and power sources. More specifically, the present application is related to utilizing materials from plants as an electrolyte in power applications.

### BACKGROUND

Approximately three billion batteries are sold in the United States annually. Many of these batteries are disposed of in conventional trash, with a smaller portion being recycled. Batteries are electrochemical devices that convert chemical energy to electrical energy to provide power to devices. Batteries generally contain materials that may be harmful to the environment. For example, mercury, lead, cadmium, and nickel, are commonly utilized and are not always properly disposed of. This can lead to harsh chemicals leaching into ground water or being into the air as a result of trash incineration processes.

Conventional batteries also have common limitations. For example, batteries stored over extended periods of time tend to lose their charge, and in some cases will begin to corrode. Corrosion can have the adverse effect of exposing chemicals that may be harmful to the device using the batteries or the container where the batteries are stored. Additionally, batteries may have moderate to severe limitations on performance in low temperatures. For example, when operated at low temperatures (e.g. near zero degrees Celsius) the internal resistance of a battery may increase and reduce the capacity of a battery by fifty percent or greater.

### SUMMARY OF THE INVENTION

The present application is directed to systems, methods and devices which utilize plant-based materials as an electrolyte in a power source. Embodiments may process leaves and stems to form materials to be included in one or more of a liquid, paste, or paper-based battery cell. In some embodiments the leaf or stem based materials may be the primary electrolyte in the battery cell, while in other embodiments the leaf or stem based materials may be combined with other materials to provide for the chemical materials within the battery cell. In additional embodiments, the leaves or stems may be processed with a textile or leather material to form a wearable cell.

In some embodiments a single leaf or stem-based battery cell may provide voltage greater than 0.81 volts. In further embodiments a plurality of cells may be placed in series in order to provide for a higher voltage. Embodiments may also provide for battery cells that will provide for substantially stable voltage output at near-freezing temperatures. Still further, embodiments may provide for battery cells that are completely biodegradable or that are at least partially biodegradable such that chemicals utilized for electrolytes that are introduced into the environment do not cause harmful contamination.

In some other embodiments, a single leaf or stem based battery cell may provide voltage greater than 0.42 volts. For further embodiment based on this, a plurality of cells may be placed in series in order to provide for a higher voltage. This particular embodiment may also provide for battery cells that will provide for another substantially stable voltage output at near-freezing temperatures. This embodiment will also provide for battery cells that are completely biodegradable such that chemicals also utilized for electrolytes that are introduced into the environment do not cause harmful contamination.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates a battery cell in accordance with an embodiment of the present application;

FIG. 2 illustrates a circuit utilizing a plurality of battery cells in accordance with an embodiment of the present application; and

FIG. 3 illustrates a process for forming a battery in accordance with an embodiment of the present application.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

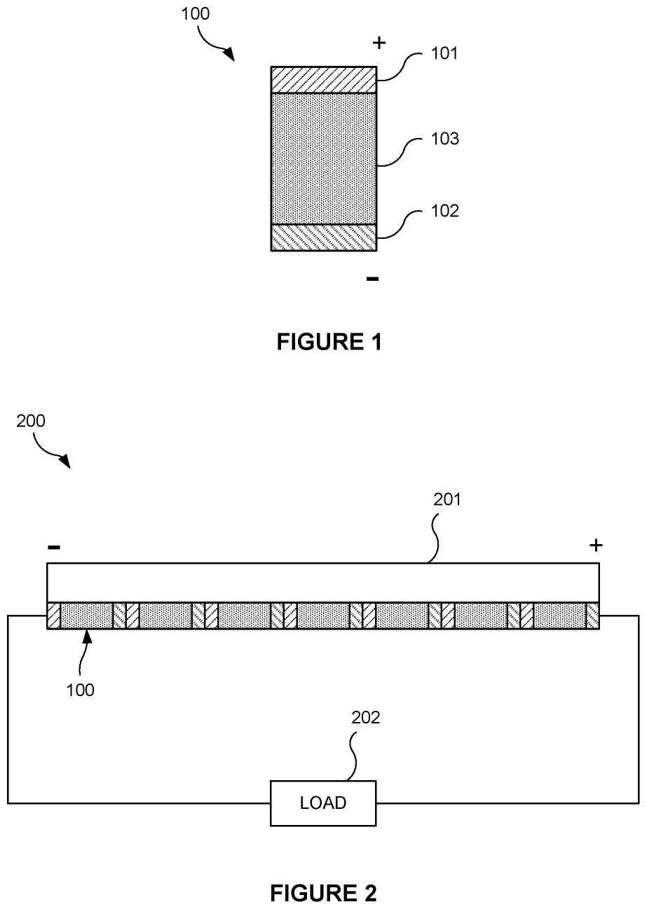

FIG. 1 illustrates a battery cell 100 in accordance with an embodiment of the present application. Cell 100 includes a cathode 101, anode 102 and electrochemical material(s) 103. Cathode 101 and anode 102 may be implemented using disparate metals such as copper and iron, zinc and carbon, lithium and manganese dioxide, and the like. It is appreciated that embodiments and inventive aspects disclosed herein are not necessarily limited to the use of any particular anode/cathode materials.

Cell 100 may be formed with an outer case of any suitable material. For example, an outer case may comprise a plastic, may utilize a zinc can, and the like. The outer case may provide the structural support for cell 100 and may function to seal electrochemical materials therein. Additionally, cell 100 may include an inner case that contains the electrochemical materials while still allowing electrochemical materials 103 to contact anode 102 and cathode 101. In embodiments where cell 100 is used in a wearable-type of device an outer case composed of a flexible material may be utilized

Electrochemical materials 103 may comprise one or more of a liquid, paste, or paper materials, at least a portion of which are derived from plant-based materials, which are described in more detail below. Additionally, in some embodiments electrochemical materials may comprise a mixture of plant-based materials and other electrolytic chemicals.

FIG. 2 illustrates a system 200 which utilizes a plurality of battery cells 201 in accordance with an embodiment of the present application. In the illustrated embodiment, load 202 requires 5.6 volts to function properly. Each of cells 100 in this example comprises a leaf or stem-based cell that provides ˜0.81 Volts. Seven of such cells are disposed in series to provide the requisite 5.6 volts. Accordingly, embodiments are able to provide selectively higher ranges of voltage according to preferred end uses. It is notable that while the illustrated figure depicts a plurality of cells 201 as separate cells, the plurality may be encased in a single packaged battery for end use.

The following description details specific methods and materials to create a plant based battery cell, such as depicted at 100. It is appreciated that while specific plants, and processing methods are described, other processing methods to extract the usable electrolytes, and other plants that have similar properties to the specific plants described, are within the scope of the concepts described herein.

A leaf or stem from a tree with the botanical name Baphia Pubescens (aka Benin Camwood) was utilized in one example embodiment. In the other example embodiment, a leaf or stem from a tree with the botanical name Gmelina Arborea was utilized. Leaves or stems from these trees were first harvested and washed in clean water to remove dirt. The leaves or stem may then be dried or may be processed when fresh. When using a dry leaf methods may include pulverizing the leaf (or leaves) into fine dust while preventing air into the container. With the dust, aloe vera juice may be introduced and mixed in order to form a paste. A fresh leaf or stem may be crushed/blended, and fluid may be extracted to form a paste. This paste formation may include squeezing the crushed leaf or stem through a filtration system to extract fluid and leave paste remaining. It is appreciated that both the paste and liquid extracted from the above processes may be utilized in either a liquid-based or paste-based cell respectively.

In one example embodiment, the paste produced may be heated to 60 degrees Celsius to encourage bonding and to evaporate a portion of remaining liquid in the paste material. It is appreciated that heating is optional, and may not be preferable in embodiments where no water was used to form the paste material.

With the paste material formed, the paste may be cut or subdivided into smaller parts. For example, in one embodiment the cut paste portions were encased into precut plastic pouches that were approximately 1 mm×1 mm. However, different sizes (both smaller and larger) could be utilized. In some embodiments, the paste may be encased with other dielectric materials or non-conduction materials. Further, the paste may be mixed with other electrolytic pastes or substances.

In embodiments, the plastic pouches may be pre-installed or post-installed with electrodes. As discussed above with respect to FIG. 1, electrodes will comprise disparate metals. Further, the electrodes will be disposed so as to prevent a respective anode and cathode from contacting one another. The pouches may then be sealed, such as by heat, glue, or any other method that can be utilized with the material used for encasement.

In one example embodiment that utilizes only the above-referenced leaves or stems with no other materials, each cell as measured a voltage generally hovering around 0.81 volt cell. Additionally, as described above, multiple cells may be connected in series to achieve an additive voltage. In one specific example embodiment multiple cells (10) were connected to power an LED light. Voltage measured from the battery cells was 8.1V and current measured at the input of the LED light was 2.0 micro amps.

Another method may include making a paper cell. In one example, one or more leaves may be processed as described above to create the paste or liquid ingredients. Further, in one example embodiment pieces of paper were cut (e.g. into 3×3 cm squares) and dipped into a container with the fluid/paste ingredients. The container with the pieces of paper and electrolyte ingredients may be heated (e.g. for 2 minutes in a microwave) to allow the fluid blend into the paper material, or if water was added in concentrate, to allow water evaporate. While still hot, the container may be taken out of the microwave and covered to prevent any further evaporation. In this example embodiment, after about one minute, the covered container was then put in a freezer while still hot. After about 10 minutes the container was brought out of the freezer and the cut papers are taken out and laid on a clean platform. While the papers are still moist, electrodes may be placed on each end of the papers. For example, disparate metals may perforate the papers in a plurality of places and the electrodes may be secured to the paper electrolyte material. It is appreciated that in this example embodiment, the paper in the cell is kept in a moist condition to remain functional. Still further, such a cell has been observed to cease functioning when the paper sufficiently dries, but will begin functioning again as a battery when the paper is re-moistened.

Yet another method may include making a wearable cell. In one example, one or more leaves or stems may be processed as described above to create the paste or liquid ingredients. Further, in one example embodiment, a textile material or leather product is cut (e.g. in sizes of 3 by 3 cm, but smaller or larger measurements will suffice). The pieces of textile are then dipped into the container with the electrolyte ingredients. The container with the pieces of textile or leather are heated (e.g. for about two minutes) to allow fluid blend into material, or if water was added in concentrate, to allow water evaporate. While still hot, the container is taken out of the microwave and covered to prevent any further evaporation. After about one minute, the covered container is put in a freezer while still hot. After about 10 minutes the container is brought out of the freezer and laid on a clean platform.

In one other method, three or more leaves are blended with a table spoon scoop of sharp sand and in this embodiment the mixture are heated for about two minutes with tightly closed lid to allow complete blending of fluid with the sand with care taken to minimize evaporation. While the mixture is still hot, it is put in a freezer. After about 10 minutes the container could be taken out of the freezer and ready for packaging.

While the materials are still moist, disparate electrodes in the form of electro-textile materials cut in the sizes 5 mm by 40 mm are laid out. Two electro-textiles, one copper based and the other of any other metal is attached to each material, e.g., with the help of epoxy. As with the paper cell, the wearable cell must also be kept in a moist condition by screening or any appropriate method. Wearable cells formed by this method have been observed to exhibit the performance noted above with respect to the liquid and paste cells.

It is appreciated that various alterations may be implemented in making the disclosed battery cells. For example, the fluid concentrate could be used entirely, or the paste may be made available without applying water. Furthermore, a crushed leaf or stem could be mixed in water or the undiluted fluid may be squeezed out of the leaf or stem. Different processes for extracting the fluid (e.g. instead of filtering) are also possible. The crushed leaf or stem paste left behind after extracting the fluid is used for the “paste cell”, the liquid either in the diluted form with water or the concentrate is used as the electrolyte in the “liquid cell” or soaked with paper for “paper cell” or “wearable cell”. The bark or the bark oil of the utilized plants (Baphia Pubescens or Gmelina Arborea), may also be processed and utilized to form the disclosed cells.

It is appreciated that the above plant-based electrolyte batteries may be utilized to power various devices. For example, embodiments of the invention can be used as batteries in cell phones, low power CMOS, low power transmitters, and can be adapted for use in computers, for powering security lamps, in powering LED's or memory devices. There are also applications in implantable or wearable devices. Additionally, these batteries may be utilized in low temperatures (e.g. temperatures in the order of (−60° C.) without significant falloff of performance.

In another embodiment, a battery may be partially made and stored in dry form. For example, when the leaves or stems are ground, they may be inserted into a casing with the electrodes. In this form, the battery may be stored for long periods without risk of normal corrosion and degradation that would be observed with other types of batteries. When the battery is needed at a later point in time, water (or some other liquid) may be added to the stored cell in order to activate the battery.

Specifically for the present embodiment, the chemical analysis of these extracts for multi-element determination was done by Inductively Coupled Plasma Mass Spectrometry (ICP-MS) using National Institute of Standards and Technology (NIST)—traceable calibration standards. Sample sizes of 0.7 g to 2.5 g were used. Prior to analysis, each sample was completely digested using nitric acid/hydrogen peroxide mixtures and presented in the Tables below:

TABLE 1
Analytical profile of the stem of Baphia Pubescens

| Analyte | [mg/kg] | Analyte | [mg/kg] | Analyte | [mg/kg] |
|---|---|---|---|---|---|
| K | 4699 | B | 2.8 | Yb | 0.22 |
| Ca | 1120 | Cd | 1.4 | Ce | 0.14 |
| Mg | 848 | Pb | 0.65 | Eu | 0.14 |
| Fe | 97 | As | 0.65 | La | 0.14 |
| Zn | 85 | Ag | 0.58 | Tl | 0.14 |
| Mn | 76 | Ga | 0.43 | Pr | 0.07 |
| Al | 49 | V | 0.36 | Ho | 0.07 |
| Na | 39 | Nd | 0.36 | Tm | 0.07 |
| Rb | 16 | Sm | 0.36 | Lu | 0.07 |
| Sr | 9.1 | Gd | 0.36 | U | 0.07 |
| Cu | 5.8 | Dy | 0.29 | Er | 0.22 |
| Ba | 5.1 | Se | 0.22 | Be | ND |
| Ni | 4.0 | | | | |

TABLE 2
Analytical profile of the leaf of Baphia Pubescens

| Analyte | [mg/kg] | Analyte | [mg/kg] | Analyte | [mg/kg] |
|---|---|---|---|---|---|
| K | 2850 | Cd | 1.0 | Ga | 0.17 |
| Ca | 1205 | Ba | 0.90 | Eu | 0.13 |
| Mg | 992 | As | 0.52 | La | 0.13 |
| Mn | 28.8 | Ag | 0.43 | Tl | 0.13 |
| Na | 27.8 | Gd | 0.34 | V | 0.09 |
| Zn | 21.8 | Nd | 0.30 | Pr | 0.09 |
| Fe | 20.8 | Sm | 0.30 | Ho | 0.09 |
| Rb | 8.0 | Se | 0.22 | Tm | 0.09 |
| Sr | 6.4 | Dy | 0.22 | Lu | 0.09 |
| B | 5.2 | Er | 0.22 | U | 0.09 |
| Al | 3.8 | Yb | 0.22 | Pb | 0.17 |
| Ni | 1.9 | Ce | 0.17 | Be | ND |
| Cu | 1.6 | | | | |

TABLE 3
Analytical profile of the leaf of Gmelina Arborea

| Analyte | [mg/kg] | Analyte | [mg/kg] | Analyte | [mg/kg] |
|---|---|---|---|---|---|
| K | 1000 | As | 0.92 | Be | 0.10 |
| Ca | 453 | Ba | 0.68 | V | 0.10 |
| Mg | 116 | Gd | 0.28 | Ce | 0.10 |
| Na | 37 | Sm | 0.26 | Tl | 0.10 |
| Fe | 30 | Nd | 0.24 | Se | 0.08 |
| Mn | 13 | Ag | 0.24 | La | 0.08 |
| Zn | 7.2 | Dy | 0.22 | Pr | 0.06 |
| Al | 4.7 | Er | 0.20 | Ho | 0.06 |
| Rb | 4.2 | Yb | 0.18 | Tm | 0.06 |
| Sr | 4.2 | Pb | 0.14 | Lu | 0.06 |
| Ni | 3.0 | B | 0.14 | U | 0.06 |
| Cu | 3.0 | Ga | 0.14 | Eu | 0.12 |
| Cd | 0.94 | | | | |

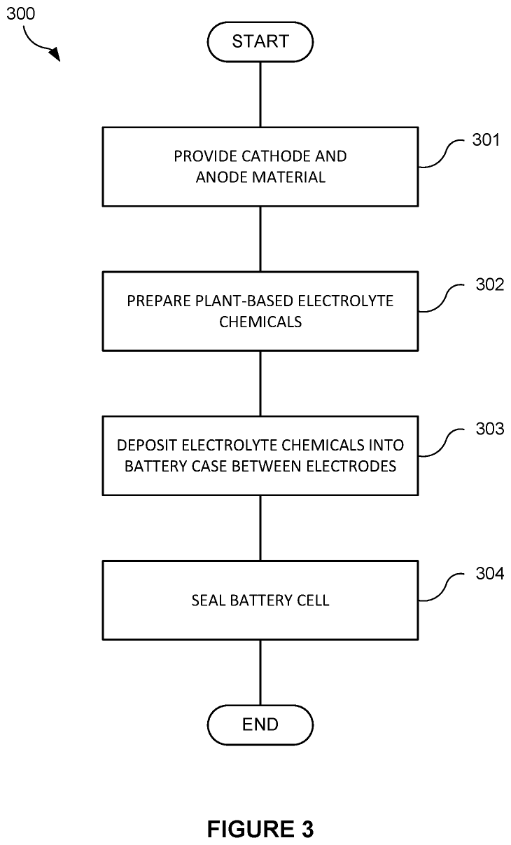

FIG. 3 illustrates a method 300 for forming a battery in accordance with embodiments of the present application. Method 300 begins with providing one or more cathode and anode materials 301. As described above, these materials will be different metals and may comprise any suitable materials to fulfill their required functionality. At step 302 the method prepares plant-based electrolyte chemicals. This preparation may include creating the liquid, paste, paper or textile-based ingredients described above. It is also appreciated that this step may be optional within an implemented or later claimed method as the preparation could be done by a materials supplier, whereas forming of the battery may be implemented by a manufacturer using the supplied materials. Method 300 further includes, at step 303, depositing electrolyte chemicals into a battery case between the anode and cathode (collectively electrodes). It is appreciated that the depositing step may include utilizing only the plant-based electrolyte materials, it may include utilizing a combination of materials, and/or it may include inserting additional dielectric materials. Method 300 further includes sealing the battery cell. Such a seal could be a permanent seal, or it could be a seal that could be opened and closed, for example, in order to allow for the addition of fluid to a stored powder-based battery.

Although embodiments of the present application and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and steps described in the specification. As one of already skilled in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Moreover, the scope of the present application is not intended to be limited to the particular embodiments of the process, machine, manufacture, and composition of matter, means, methods and steps described in the specification.

1. A battery cell comprising,
an anode comprising a metallic material;
a cathode comprising a metallic material that is disparate from the anode material; and
at least one electrolyte material disposed between the anode and cathode, wherein at least one electrolyte material includes a plant-based material.

2. The battery cell of claim 1 wherein the plant based electrolyte material is made from leaves and stems extract of Baphia Pubescens or Gmelina Arborea.

3. The battery cell of claim 1 wherein the electrolyte material comprises primarily a leaf or stem-based material.

4. The battery cell of claim 3 wherein the plant based electrolyte material is in liquid form.

5. The battery cell of claim 3 wherein the plant based electrolyte material is in paste form.

6. The battery cell of claim 3 wherein the plant based electrolyte material is in paper form.

7. The battery cell of claim 3 wherein the plant based electrolyte remains effective below −60° C.

8. The battery cell of claim 3 wherein the plant based electrolyte remains effective above 80° C. without loss of moisture

9. The battery cell of claim 3 wherein the battery cell yields a voltage of approximately 0.81 Volts.

10. The battery cell of claim 1 further comprising a plurality of said battery cells connected in series.

11. The battery cell of claim 1 wherein the battery cell is a wearable cell.
